(19) United States
(12) Patent Application Publication
(10) Pub. No.: US 2026/0058378 A1
(43) Pub. Date: Feb. 26, 2026

(54) CABLE ASSEMBLY

(71) Applicants: TE Connectivity Solutions GmbH, Schaffhausen (CH); TE Connectivity Nederland B.V., 's-Hertogenbosch (NL)

(72) Inventors: Albert Tsang, Middletown, PA (US); Robert Lee Putt, JR., Middletown, PA (US); Julia Anne Lachman, Middletown, PA (US); Rutger Wilhelmus Smink, 's-Hertogenbosch (NL); Jacobus Nicolaas Tuin, 's-Hertogenbosch (NL); Linda Ellen Shields, Middletown, PA (US)

(21) Appl. No.: 18/809,418

(22) Filed: Aug. 20, 2024

(51) Int. Cl. H01R 4/02; H01R 43/02

(52) U.S. Cl. CPC H01R 4/023; H01R 43/02

(57) ABSTRACT

A cable assembly includes a cable that includes a cable conductor having an end portion. The cable assembly includes a contact terminated to the end portion of the cable conductor. The contact includes a mating end and a terminating end. The mating end has a mating interface configured to be mated to a mating contact. The terminating end is configured to be joined to the end portion of the cable conductor at a termination. The terminating end includes a folded portion to increase a thickness of the terminating end at the termination.

### BACKGROUND OF THE INVENTION

The subject matter herein relates generally to cable assemblies.

Some electrical systems utilize electrical connector assemblies to interconnect various electrical components. High speed electrical connector assemblies suffer from problems with cross talk and can exhibit signal degradation, such as along long signal traces on circuit boards. As systems signal speeds increase, the data path generally needs to improve accordingly or the length of the data path needs to decrease. Some communication systems make use of shielded cables to form data channels. The cables include conductors terminated to ends of contacts that define mating components for mating between the electrical connector assemblies. The contacts may be crimped, soldered or welded to the conductors of the cables, or otherwise joined. Typically, the joining area of the contact is limited in material thickness due to design requirements on the mating end of the contact. If a thin joining feature is used in the cable termination area, the resulting pull strength of the cable termination joint may be low and require additional support such as potting for strain relief. Some known contacts attempt to solve the issues with the thin joining feature by using multi-thickness stock materials that are skived or milled to form the multiple thicknesses. However, such processes can lead to higher costs and also can add unwanted residual stresses in the raw material, which can lead to dimensional defects during manufacturing.

A need remains for a contact for a cable assembly having more material in the joining area in order to more closely match the thickness of the conductors in the cable to ensure a robust and reliable joint created between the contact and the cable conductor.

### BRIEF DESCRIPTION OF THE INVENTION

In one embodiment, a cable assembly is provided and includes a cable that includes a cable conductor having an end portion. The cable assembly includes a contact terminated to the end portion of the cable conductor. The contact includes a mating end and a terminating end. The mating end has a mating interface configured to be mated to a mating contact. The terminating end is configured to be joined to the end portion of the cable conductor at a termination. The terminating end includes a folded portion to increase a thickness of the terminating end at the termination.

In another embodiment, a cable assembly is provided and includes a cable that includes a cable conductor having an end portion. The cable assembly includes a contact terminated to the end portion of the cable conductor. The contact includes a stamped and formed body having a sheet thickness. The contact includes a mating end and a terminating end. The mating end has a mating interface configured to be mated to a mating contact. The terminating end is configured to be joined to the end portion of the cable conductor at a termination. The body at the terminating end is folded over to form a lap joint at the termination. The lap joint has a thickness greater than the sheet thickness.

In another embodiment, a method of forming a cable assembly is provided. The method provides a contact including a body extending between a mating end and a terminating end. The method folds the body at the terminating end to form a lap joint at the terminating end. The lap joint may have a thickness greater than a thickness of the body. The method joins the lap joint to a conductor of a cable at a seam.

### BRIEF DESCRIPTION OF THE DRAWINGS

FIG. 1 is a perspective view of an exemplary embodiment of an electrical connector system illustrating a first connector assembly and a second connector assembly that may be directly mated together in accordance with an exemplary embodiment.

FIG. 2 is a perspective view of the cable assembly in accordance with an exemplary embodiment.

FIG. 3 is a sectional view of the cable assembly in accordance with an exemplary embodiment.

FIG. 4 is a perspective view of the cable assembly in accordance with an exemplary embodiment.

FIG. 5 is a sectional view of the cable assembly in accordance with an exemplary embodiment.

FIG. 6 is a perspective view of the cable assembly in accordance with an exemplary embodiment.

FIG. 7 is a sectional view of the cable assembly in accordance with an exemplary embodiment.

FIG. 8 is a perspective view of the cable assembly in accordance with an exemplary embodiment.

FIG. 9 is a sectional view of the cable assembly in accordance with an exemplary embodiment.

FIG. 10 is a perspective view of the cable assembly in accordance with an exemplary embodiment.

FIG. 11 illustrates the terminating end of the contact of the cable assembly shown in Figure in accordance with an exemplary embodiment.

FIG. 12 is a perspective view of the cable assembly in accordance with an exemplary embodiment.

FIG. 13 is a perspective view of the cable assembly in accordance with an exemplary embodiment.

FIG. 14 is a perspective view of the cable assembly in accordance with an exemplary embodiment.

FIG. 15 is a cross-sectional view of the cable assembly in accordance with an exemplary embodiment.

FIG. 16 is a perspective view of the cable assembly in accordance with an exemplary embodiment.

FIG. 17 is a cross-sectional view of the cable assembly in accordance with an exemplary embodiment.

FIG. 18 is a perspective view of the cable assembly in accordance with an exemplary embodiment.

FIG. 19 is a cross-sectional view of the cable assembly in accordance with an exemplary embodiment.

FIG. 20 is a perspective view of the cable assembly in accordance with an exemplary embodiment.

### DETAILED DESCRIPTION OF THE INVENTION

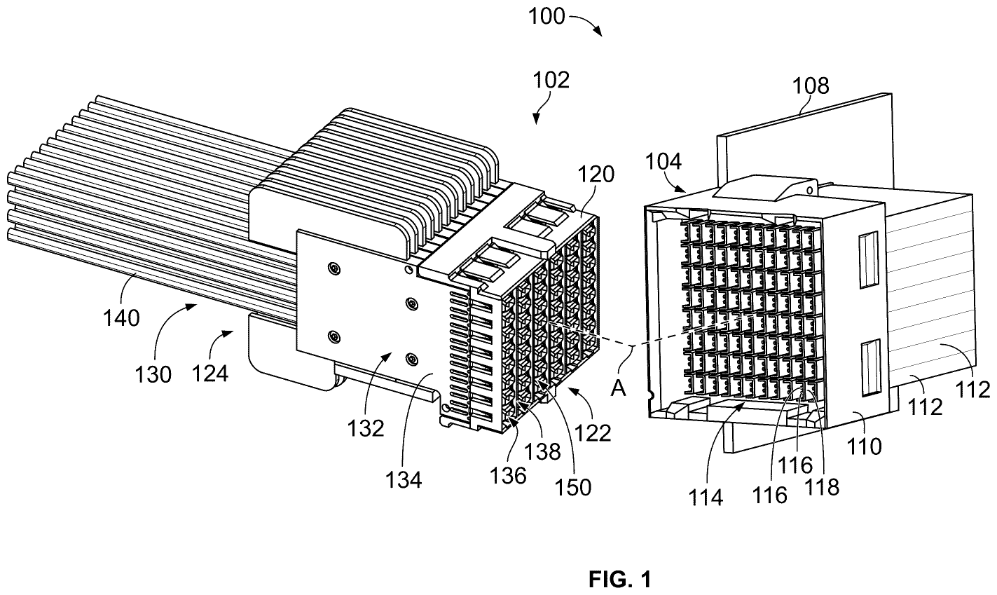

FIG. 1 is a perspective view of an exemplary embodiment of an electrical connector system 100 illustrating a first connector assembly 102 and a second connector assembly 104 that may be directly mated together. The first connector assembly 102 and/or the second connector assembly 104 may be referred to hereinafter individually as a “connector assembly” or collectively as “connector assemblies”. The connector assemblies 102, 104 are electrical connector assemblies, such as high speed data communication connectors. The connector assemblies 102, 104 may be considered mating electrical connectors or mating connector assemblies of each other having complimentary mating interfaces. In the illustrated embodiment, the first connector assembly 102 is a plug connector and the second connector assembly 104 is a receptacle connector.

The first connector assembly 102 and/or the second connector assembly 104 may be a board mounted connector assembly. The first connector assembly 102 and/or the second connector assembly 104 may be a cable connector assembly. In the illustrated embodiment, the first connector assembly 102 is a cable connector assembly electrically connected to cables 140 and the second connector assembly 104 is a board connector assembly electrically connected to a circuit board 108. The first and second connector assemblies 102, 104 are electrically connected at a separable mating interface. A mating axis A extends through the first and second connector assemblies 102, 104. The first and second connector assemblies 102, 104 are mated together in a direction parallel to and along the mating axis A. For example, the mating end of the first connector assembly 102 may be plugged into a receptacle at the mating end of the second connector assembly 104.

The first connector assembly 102 includes a connector housing 120 that holds a plurality of cable assemblies 130. The cable assemblies 130 extend from the housing 120, such as a rear of the connector housing 120. Each cable assembly 130 includes the cable 140 and corresponding contact(s) 150. In various embodiments, the contacts 150 are arranged in contact wafers 132 arranged in a contact wafer stack. Any number of contact wafers 132 may be provided in the contact wafer stack to change the number of contacts 150 at the mating interface for mating with the second connector assembly 104. Each contact wafer 132 includes a substrate or support body 134 for supporting the contacts 150. The support body 134 may be an overmold body overmolded over the contacts to hold the contacts 150 relative to each other. The contact wafer 132 may include a leadframe that is stamped and formed to form the contacts 150. The contacts 150 are configured to be electrically connected to corresponding conductors of the cables 140 forming data channels through the first connector assembly 102 to allow data communication between various components of the communication system.

In an exemplary embodiment, the contacts 150 are signal contacts. The contacts 150 may be arranged in pairs defining differential pairs. The contacts 150 may include pins, sockets, spring beams, blades or other types of contacts at the mating ends of the contacts. In the illustrated embodiment, the pairs of contacts 150 are arranged in rows defining a pair-in-row connector interface. In alternative embodiments, the pairs of contacts 150 may be arranged in columns defining a pair-in-column connector interface.

In an exemplary embodiment, each contact wafer 132 has a shield structure 136 for providing electrical shielding for the contacts 150. For example, the shield structure 136 may include contact shields 138 associated with the corresponding contacts 150. The contact shields 138 may be C-shields providing shielding on three sides of the contacts 150, such as surrounding the pairs of the contacts 150. The contact shields 138 may have other shapes or structures in alternative embodiments. In an exemplary embodiment, the shield structure 136 is electrically connected to the second connector assembly 104 and/or the cables 140. For example, the shield structure 136 may be electrically connected to the second connector assembly 104 by extensions (e.g. beams or fingers) extending from the contact wafers 132 that engage the second connector assembly 104.

The connector housing 120 is manufactured from a dielectric material, such as a plastic material, and provides isolation between the contacts 150 and the shield structure 136. The connector housing 120 includes a mating end 122 and a cable end 124. The mating end 122 may be at a front or a top of the connector housing 120. The cable end 124 may be at a rear or a bottom of the connector housing 120. In various embodiments, the cable end 124 is opposite the mating end 122, such as with the cables 140 extending from the contact wafers 132 in a direction parallel to the mating axis A. The contacts 150 are received in the connector housing 120 and held therein at the mating end 122, such as for mating to the second connector assembly 104. The contacts 150 are arranged in a matrix of rows and columns. In the illustrated embodiment, at the mating end 122, the rows are oriented horizontally and the columns are oriented vertically. Other orientations are possible in alternative embodiments. Any number of contacts 150 may be provided in the rows and columns.

The second connector assembly 104 includes a connector housing 110 holding contact wafers 112. The connector housing 110 has walls defining a chamber 114 at a mating end of the second connector assembly 104. A mounting end of the second connector assembly 104 is mounted to an electrical component, such as the circuit board 108. Optionally, the mounting end may be substantially perpendicular to the mating end. In the illustrated embodiment, the first connector assembly 102 is coupled to the mating end, such as being received in the chamber 114 through the mating end. The connector housing 120 engages the walls to hold the first connector assembly 102 in the chamber 114.

The second connector assembly 104 includes signal contacts 116 and ground shields 118 extending into the chamber 114. In an exemplary embodiment, the signal contacts 116 are arranged as differential pairs. The signal contacts 116 may include pins, sockets, spring beams, blades or other types of contacts at the mating ends of the signal contacts 116. The ground shields 118 are positioned between the differential pairs to provide electrical shielding between adjacent differential pairs. In the illustrated embodiment, the ground shields 118 are C-shaped and provide shielding on three sides of the pair of signal contacts 116. Other shapes are possible in alternative embodiments.

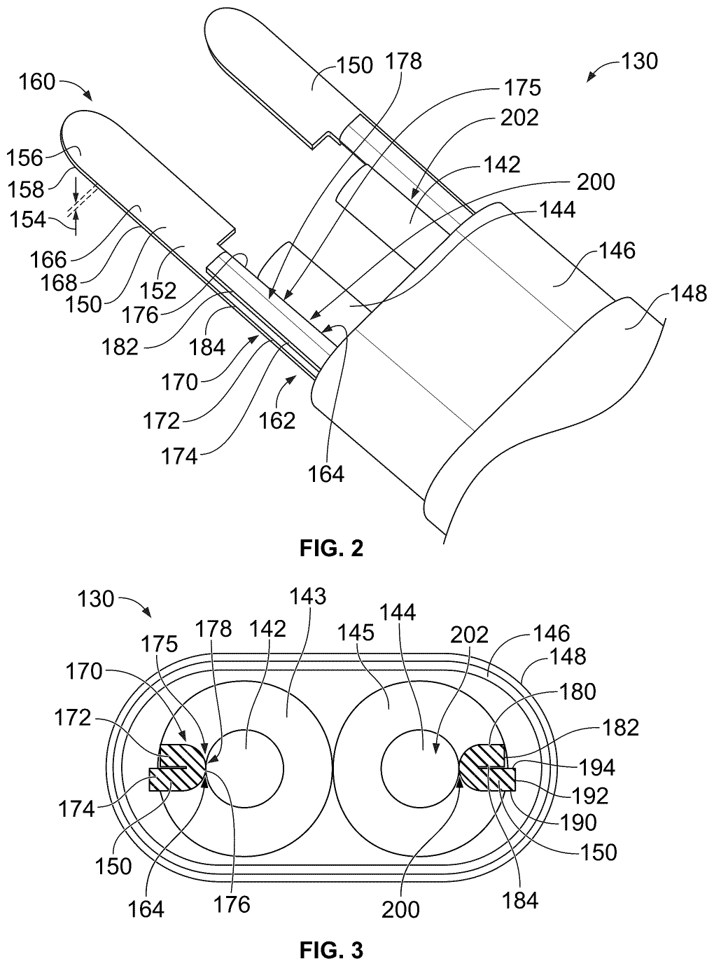

FIG. 2 is a perspective view of the cable assembly 130 in accordance with an exemplary embodiment. FIG. 3 is a sectional view of the cable assembly 130 in accordance with an exemplary embodiment. The cable assembly 130 includes the cable 140 and the contact(s) 150. In the illustrated embodiment, the cable assembly 130 includes a pair of the contacts 150. However, the cable assembly 130 may include greater or fewer contacts 150 in alternative embodiments.

The cable 140 includes at least one conductor and at least one insulator supporting the at least one conductor. In the illustrated embodiment, the cable 140 includes a first cable conductor 142 and a second cable conductor 144. The pair of conductors 142, 144 may convey differential signals. In the illustrated embodiment, the cable 140 includes a first insulator 143 and a second insulator 145 supporting the first and second conductors 142, 144, respectively. The insulators 143, 145 may be extruded with the conductors 142, 144. In alternative embodiments, the cable 140 may include a single insulator holding both of the conductors 142, 144. In an exemplary embodiment, the cable 140 includes a cable shield 146 surrounding the insulators 143, 145. The cable shield 146 provides shielding for the conductors 142, 144. The cable 140 may include one or more drain wires (not shown). In an exemplary embodiment, the cable 140 includes a cable jacket 148 surrounding the cable shield 146.

In an exemplary embodiment, the cable 140 is prepared by stripping the end of the cable to expose portions of the conductors 142, 144. The jacket 148 may be stripped to expose a portion of the cable shield 146. The contacts 150 are configured to be terminated to the exposed ends of the conductors 142, 144. For example, the contacts 150 may be soldered or welded to the exposed ends of the conductors 142, 144, such as being spot welded, laser welded, friction stir welded, or ultrasonically welded to the conductors 142, 144. The shield structure, such as the contact shields 138 (shown in FIG. 1) may be electrically connected to the cable shield 146.

The contact 150 is a metal contact being electrically conductive, such as a copper or copper alloy contact. The contact 150 may include one or more plating layers. In an exemplary embodiment, the contact 150 is a stamped and formed contact. For example, the contact 150 may be stamped from a planar metal sheet and formed into a predetermined shape for the particular application. The contact 150 may be stamped as a leadframe with multiple other contacts 150.

The contact 150 includes a body 152 having a thickness 154 defined between a first surface 156 and a second surface 158. The thickness 154 is defined by the thickness of the metal sheet from which the contact 150 is stamped. The first surface 156 may be an upper surface and the second surface 158 may be a lower surface. The contact 150 extends between a mating end 160 and a terminating end 162. The mating end 160 includes a mating interface configured to be mated with the signal contact 116 of the second connector assembly 104. The mating end 160 may include a pin, a socket, a spring beam, a blade, or another type of contact. The terminating end 162 is configured to be terminated to the end portion or exposed portion of the corresponding cable conductor 142, 144 at a termination 164. For example, the terminating end 162 may be soldered or welded to the corresponding cable conductor 142, 144 at a seam 200 defined by the termination 164. For example, the termination 164 may form a soldered connection or a welded connection at the seam 200 between the contact 150 and the corresponding cable conductor 142, 144. In an exemplary embodiment, the stamped and formed body 152 includes broad sides 166 and edge sides 168. The broad sides 166 are defined by the main planar surfaces of the metal sheet, such as the first surface 156 and the second surface 158. The edge sides 168 are defined by the cut edges through the thickness of the body 152 formed during the stamping process. The edge sides 168 extend between the first and second surfaces 156, 158.

In an exemplary embodiment, the contact 150 is formed to include a folded portion 170 at the terminating end 162. For example, one of the broad sides 166 is folded over on itself at the folded portion 170 to form a lap joint 175 at the terminating end 162. The folded portion 170 may be flattened, compressed, or coined to create a rigid structure along the lap joint 175. The termination 164 is configured to be soldered or welded to the end portion of the cable conductor 142, 144 along the folded portion 170. The folded portion 170 is folded over or otherwise bent to increase the thickness of the terminating end 162 at the termination 164. In an exemplary embodiment, the folded portion 170 includes multiple layers stacked to form a layered structure to increase the thickness of the terminating end 162. The layered structure forms the lap joint 175 where the portions of the body 152 overlap each other. The layered structure may have a thickness greater than a thickness of the body 152 at the lap joint 175. The thickness may be approximately twice the thickness if the lap joint includes a single fold or approximately three times the thickness if the lap joint includes a double fold (for example, defined by the layers formed by the overlapping of the portions). The layered structure may be coined to compress the layers together, which might make the thickness slightly less than double or triple the thickness due to the coining process. The increased thickness increases the amount of material available at the termination 164 for soldering or welding to the cable conductor 142, 144. The increased thickness in the joining area improves the connection between the contact 150 and the cable conductor 142, 144. The increased thickness improves reliability and robustness of the connection. The increased thickness allows for a higher strength joint between the termination 164 and the cable conductor 142, 144. The folded portion 170 provides a cross-sectional area at the termination 164 that is closer to a cross-sectional area of the cable conductor 142, 144. For example, without the folded portion 170, the cross-sectional area of the contact may be less than 50% of the cross-sectional area of the cable conductor 142, 144 or even less than 25% of the cross-sectional area of the cable conductor 142, 144, but the cross-sectional area of the contact 150 at the folded portion 170 may be greater than 50% of the cross-sectional area of the cable conductor 142, 144. For example, the thickness of the contact 150 at the folded portion 170 may be greater than half a diameter of the cable conductor 142, 144. In an exemplary embodiment, the folded portion 170 doubles the thickness of the contact 150 at the termination 164. However, in other embodiments, the contact 150 may be folded over multiple times to triple (or more) the thickness of the contact 150 at the termination 164.

In an exemplary embodiment, the folded portion 170 includes a first panel 172 and a second panel 174 stacked on each other to increase the thickness of the terminating end 162. For example, the first and second panels 172, 174 may be vertically stacked with the first panel 172 defining an upper panel and the second panel 174 defining a lower panel. The overlapping area defined by the first and second panels 172, 174 forms the lap joint 175. In an exemplary embodiment, the folded portion 170 includes a folded hem 176 defining a connecting portion 178 between the first panel 172 and the second panel 174. In the illustrated embodiment, the folded hem 176 is folded 180° such that the surfaces of the first and second panels 172, 174 abut against each other. In various embodiments, the first and second panels 172, 174 may be welded or soldered at the distal end(s) of the first and second panels 172, 174 to mechanically and electrically connect the first and second panels 172, 174 at the ends opposite the folded hem 176. For example, the distal ends may be spot welded at one or more locations. The welding secures the first and second panels 172, 174 to each other along the lap joint 175.

In an exemplary embodiment, the first panel 172 includes a first outer side 180 extending between the hem 176 and a first edge 182 at a distal end of the first panel 172. The first outer side 180 faces outward away from the second panel 174. The first panel 172 includes a first inner side 184 opposite the first outer side 180 extending between the hem 176 and the first edge 182. The first inner side 184 faces the second panel 174. In the illustrated embodiment, the first inner side 184 is defined by the first surface 156 and the first outer side 180 is defined by the second surface 158. The second panel 174 includes a second outer side 190 extending between the hem 176 and a second edge 192 at a distal end of the second panel 174. The second outer side 190 faces outward away from the first panel 172. The second panel 174 includes a second inner side 194 opposite the second outer side 190 extending between the hem 176 and the second edge 192. In the illustrated embodiment, the second inner side 194 is defined by the first surface 156 and the second outer side 190 is defined by the second surface 158. The second inner side 194 faces the first panel 172, such as facing the first inner side 184. When the terminating end 162 is formed to include the folded portion 170, the first and second inner sides 184, 194 of the first and second panels 172, 174 face each other to form the lap joint 175.

In an exemplary embodiment, the hem 176 of the folded portion 170 extends parallel to the cable conductor 142, 144 (for example, parallel to the cable axis of the cable 140). The contact 150 is positioned to extend along the end portion of the cable conductor 142, 144. For example, the seam 200 extends along the length of the hem 176 to form a seam joint 202 along a side of the cable conductor 142, 144. In an exemplary embodiment, the connecting portion 178 abuts against the cable conductor 142, 144 to form the seam 200 and the seam joint 202. In the illustrated embodiment, the terminating ends 162 extend along the outer sides of the conductors 142, 144 such that the seam joints 202 are along the outer sides of the cable conductors 142, 144 opposite the gap between the conductors 142, 144, leaving the spacing between the conductors 142, 144 to maintain signal integrity of the signal paths. However, in other various embodiments, the terminating ends 162 may extend along other portions of the conductors 142, 144. For example, the terminating ends 162 may extend along the tops of the conductors 142, 144 or along the bottoms of the conductors 142, 144.

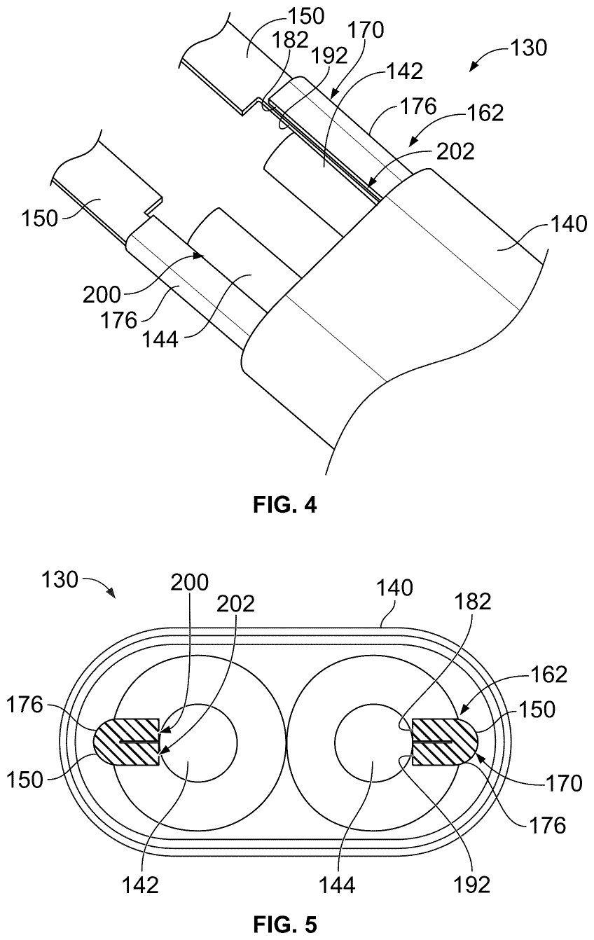

FIG. 4 is a perspective view of the cable assembly 130 in accordance with an exemplary embodiment. FIG. 5 is a sectional view of the cable assembly 130 in accordance with an exemplary embodiment. FIGS. 4 and 5 show the contacts 150 oriented in a different orientation than the embodiment shown in FIGS. 2 and 3. For example, the terminating ends 162 are inverted 180°.

In an exemplary embodiment, the hem 176 of the folded portion 170 extends parallel to the cable conductor 142, 144 (for example, parallel to the cable axis of the cable 140). The contact 150 is positioned to extend along the end portion of the cable conductor 142, 144. For example, the seam 200 extends along the length of the hem 176 to form the seam joint 202 along a side of the cable conductor 142, 144. In an exemplary embodiment, the hem 176 faces outward away from the cable conductors 142, 144. The first and second edges 182, 192 face inward to face/abut against the cable conductors 142, 144. The edges 182 and 192 may or may not be flush or similarly shaped with each other. For instance, one edge or both edges may be offset, chamfered, swaged or otherwise formed to allow for increased joining strength. The first and second edges 182, 192 form the seam 200. Both the first and second edges 182, 192 may be soldered or welded to the cable conductors 142, 144 to form the seam joint 202. The folded portion 170 increases the thickness of the contact 150 at the terminating end to provide more material at the seam 200 to form the seam joint 202. In the illustrated embodiment, the terminating ends 162 extend along the outer sides of the conductors 142, 144. However, in other various embodiments, the terminating ends 162 may extend along other portions of the conductors 142, 144, such as along the tops of the conductors 142, 144 or along the bottoms of the conductors 142, 144.

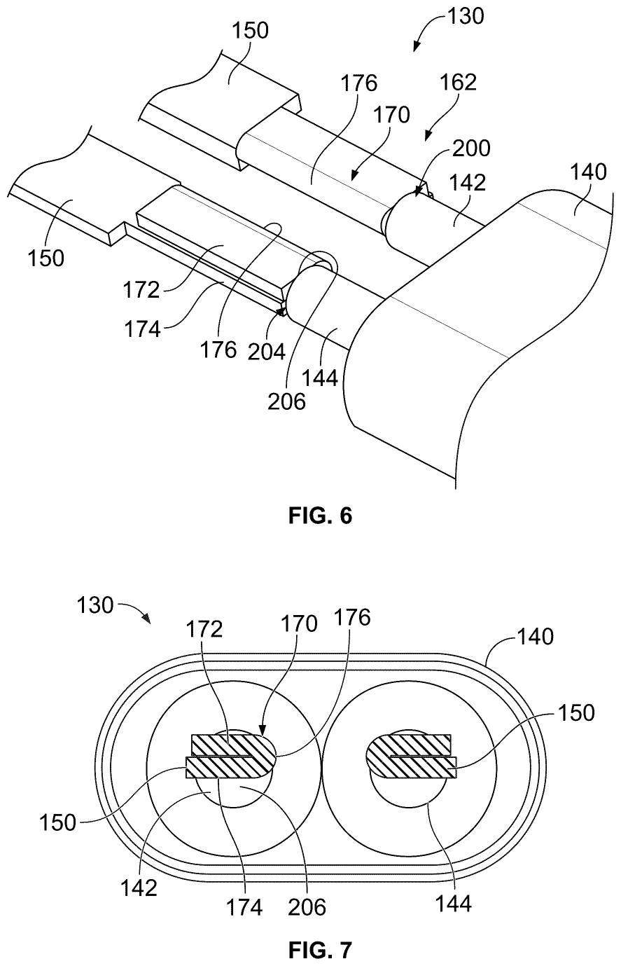

FIG. 6 is a perspective view of the cable assembly 130 in accordance with an exemplary embodiment. FIG. 7 is a sectional view of the cable assembly 130 in accordance with an exemplary embodiment. FIGS. 6 and 7 show the contacts 150 oriented in a different orientation than the embodiment shown in FIGS. 2 and 3 or the embodiment shown in FIGS. 4 and 5. For example, the terminating ends 162 form a butt joint rather than a seam joint.

In an exemplary embodiment, the hem 176 of the folded portion 170 extends parallel to the cable conductor 142, 144 (for example, parallel to the cable axis of the cable 140). The contact 150 is positioned to form a butt joint 204 at the distal end of the cable conductor 142, 144. For example, the seam 200 is provided at a distal end 206 of the terminating end 162. The distal end 206 butts directly against the distal end of the cable conductor 142, 144 to form the butt joint 204. Both the first and second panels 172, 174 are configured to be soldered or welded to the distal end of the cable conductor 142, 144 to form the butt joint 204. The increased thickness of the contact 150 at the terminating end 162 provides more material (for example, first and second panels 172, 174) at the seam 200 to form the butt joint 204.

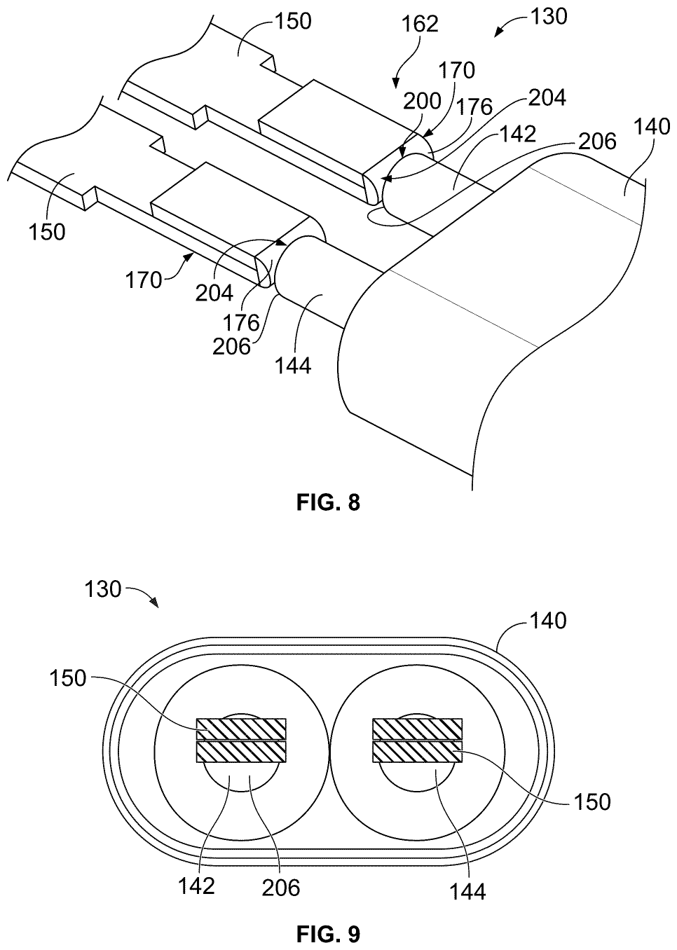

FIG. 8 is a perspective view of the cable assembly 130 in accordance with an exemplary embodiment. FIG. 9 is a sectional view of the cable assembly 130 in accordance with an exemplary embodiment. FIGS. 8 and 9 show the contacts 150 oriented in a different orientation than the embodiment shown in FIGS. 6 and 7. For example, the butt joint is formed by the hem 176 rather than the end edges.

In an exemplary embodiment, the hem 176 of the folded portion 170 extends perpendicular to the cable conductor 142, 144 (for example, perpendicular to the cable axis of the cable 140). The hem 176 is provided at the distal end 206 of the terminating end 162. The contact 150 is positioned to form the butt joint 204 at the distal end of the cable conductor 142, 144. For example, the hem 176 forms the seam 200 at the distal end 206 of the terminating end 162. The hem 176 butts directly against the distal end of the cable conductor 142, 144 to form the butt joint 204. The increased thickness of the contact 150 defined by the folded portion 170 provides more material (for example, double thickness) at the seam 200 to form the butt joint 204.

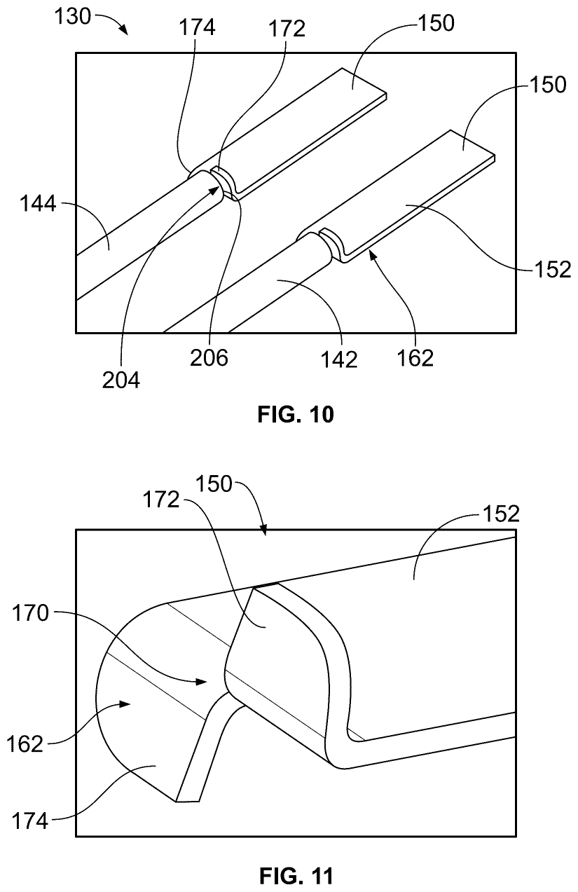

FIG. 10 is a perspective view of the cable assembly 130 in accordance with an exemplary embodiment. FIG. 11 illustrates the terminating end of the contact of the cable assembly shown in FIG. 10. FIGS. 10 and 11 show the contacts 150 having a different terminating end 162.

In an exemplary embodiment, the folded portion 170 first and second panels 172, 174 bent or folded in opposite directions. For example, the first panel 172 is folded or bent upward and the second panel 174 is folded or bent downward. In the illustrated embodiment, the first and second panels 172, 174 are bent to extend perpendicular to the other portions of the body 152. For example, the first and second panels 172, 174 are oriented 90° to the main portion of the body 152. However, in other embodiments, the first and second panels 172, 174 may be folded over 180° to form a triple layer stacked arrangement on opposite sides of the main portion of the body 152. The first and second panels 172, 174 increase the thickness (for example, in a height direction) of the terminating end.

In an exemplary embodiment, the folded portion 170 forms the butt joint 204 at the distal end 206 to connect to the distal end of the cable conductor 142, 144. The first and second panels 172, 174 butt directly against the distal end of the cable conductor 142, 144 to form the butt joint 204. The increased thickness of the contact 150 defined by the folded portion 170 provides more material at the seam to form the butt joint 204.

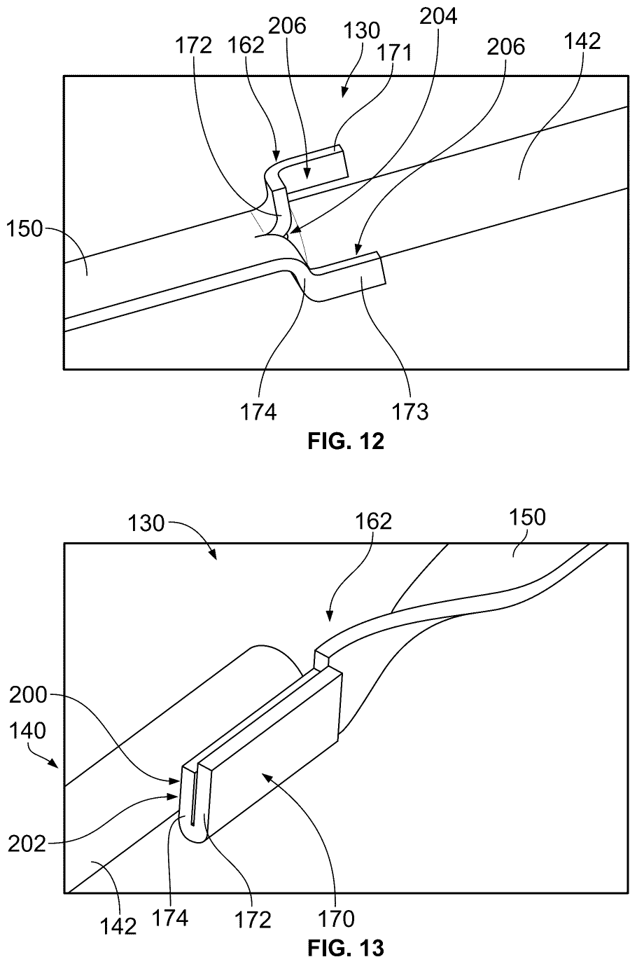

FIG. 12 is a perspective view of the cable assembly 130 in accordance with an exemplary embodiment. FIG. 12 shows the contacts 150 having a different terminating end 162 than the embodiment shown in FIG. 11. For example, FIG. 12 shows the panels 172, 174 including additional connecting tabs 171, 173 extending rearwardly to extend along the cable conductor 142. The panels 172, 174 form the butt joint 204. The connecting tabs 171, 173 are configured to form seam joints 202 along the top and bottom of the cable conductor 142. The panels 172, 174 and the connecting tabs 171, 173 may be soldered or welded to the cable conductor 142. The panels 172, 174 and the connecting tabs 171, 173 increase the amount of material for forming the joints with the cable conductor 142.

FIG. 13 is a perspective view of the cable assembly 130 in accordance with an exemplary embodiment. FIG. 13 shows the contact 150 oriented in a different orientation than the embodiment shown in FIGS. 2 and 3. In an exemplary embodiment, the folded portion 170 extends parallel to the cable conductor 142 (for example, parallel to the cable axis of the cable 140). The contact 150 is positioned to extend along the end portion of the cable conductor 142. For example, the seam 200 extends along the first panel 172 to form the seam joint 202. In an exemplary embodiment, the first panel 172 abuts the cable conductor 142 to form the seam 200. The first panel 172 may be soldered or welded to the cable conductor 142 to form the seam joint 202. The folded portion 170 increases the thickness of the contact 150 at the terminating end 162 to provide more material at the seam 200 to form the seam joint 202. In the illustrated embodiment, the terminating end 162 extends along the bottom of the conductor 142. However, in other various embodiments, the terminating ends 162 may extend along other portions of the conductors 142, 144, such as along the top of the conductor 142 (for example, with the second panel 174 forming the seam 200) or along a side of the conductor 142.

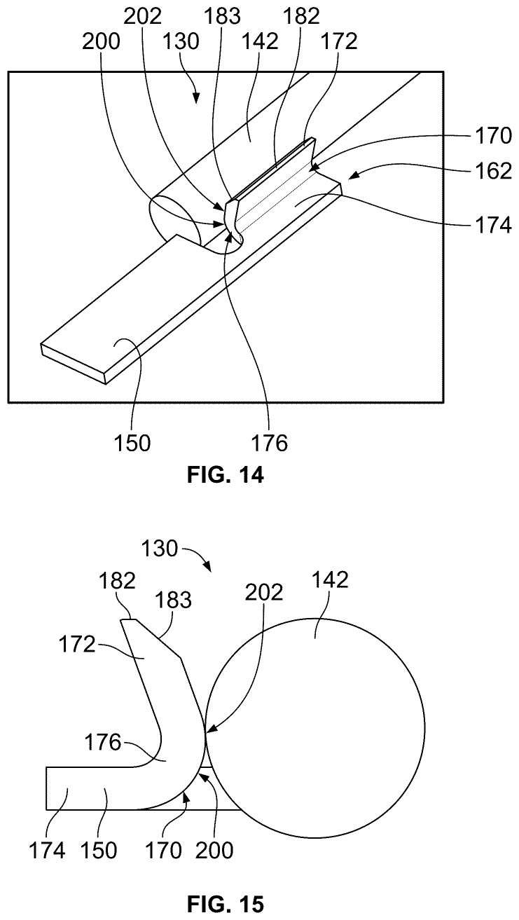

FIG. 14 is a perspective view of the cable assembly 130 in accordance with an exemplary embodiment. FIG. 15 is a cross-sectional view of the cable assembly 130 in accordance with an exemplary embodiment. FIGS. 14 and 15 show the contact 150 oriented in a different orientation than the embodiment shown in FIGS. 2 and 3. In an exemplary embodiment, the folded portion 170 extends parallel to the cable conductor 142 (for example, parallel to the cable axis of the cable 140). The contact 150 is positioned to extend along the end portion of the cable conductor 142. For example, the seam 200 extends along the first panel 172 and/or the folded hem 176 to form the seam joint 202. In the illustrated embodiment, the terminating end 162 extends along the side of the conductor 142. However, in other various embodiments, the terminating ends 162 may extend along other portions of the conductor 142.

In an exemplary embodiment, the first panel 172 is bent to an angle larger than 90°, such as approximately 110° such that the first panel 172 is partially overlapping the second panel 174. The first panel 172 may be bent to other angles between 90° and 180°. In an exemplary embodiment, the first edge 182 may include a swage 183 along the inner surface. The swage 183 forms a chamfered lead-in to guide the conductor 142 into position along the folded hem 176.

When assembled, the inner surface of the first panel 172 faces the cable conductor 142. The folded hem 176 and/or the inner surface of the first panel 172 abuts the cable conductor 142 to form the seam 200. The first panel 172 and/or the folded hem 176 may be soldered or welded to the cable conductor 142 to form the seam joint 202. The cable conductor 142 rests against the folded hem 176 and/or the inner surface of the first panel 172 for welding or soldering. The folded portion 170 increases the thickness of the contact 150 at the terminating end 162 to provide more material at the seam 200 to form the seam joint 202. For example, the folded portion 170 provides filler metal to add to the weld strength when welded to the cable conductor 142. In an exemplary embodiment, the folded portion 170 is bent away from the cable conductor 142 to create a pocket (from above) for the laser beam (or solder) used for laser welding to better contain the laser beam and direct the energy where needed to improve the weld joint at the seam 200. The angle of the folded portion 170 reduces the amount of laser beam passing through any gap between the folded portion 170 and the cable conductor 142 to improve the efficiency of the welding process. The folded hem 176 has increased thickness below the pocket to provide more material at the seam 200 to form the seam joint 202.

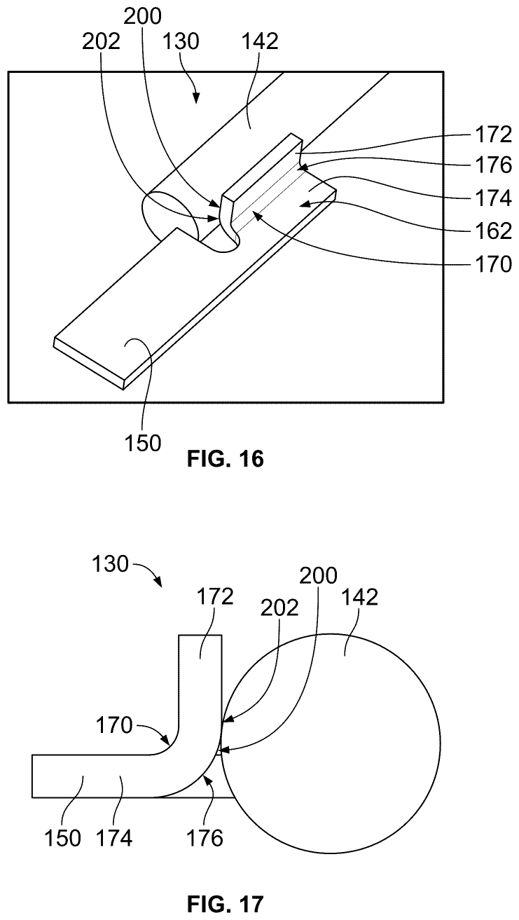

FIG. 16 is a perspective view of the cable assembly 130 in accordance with an exemplary embodiment. FIG. 17 is a cross-sectional view of the cable assembly 130 in accordance with an exemplary embodiment. FIGS. 16 and 17 show the contact 150 oriented in a different orientation than the embodiment shown in FIGS. 14 and 15. For example, in the illustrated embodiment of FIGS. 16 and 17, the first panel 172 is bent 90° relative to the second panel 174. The first panel 172 is perpendicular to the second panel 174.

In an exemplary embodiment, the folded portion 170 extends parallel to the cable conductor 142 (for example, parallel to the cable axis of the cable 140). The contact 150 is positioned to extend along the end portion of the cable conductor 142. For example, the seam 200 extends along the first panel 172 and/or the folded hem 176 to form the seam joint 202 along the side of the cable conductor 142. However, in other various embodiments, the terminating ends 162 may extend along other portions of the conductor 142.

When assembled, the inner surface of the first panel 172 faces the cable conductor 142. The folded hem 176 and/or the inner surface of the first panel 172 abuts the cable conductor 142 to form the seam 200. The first panel 172 and/or the folded hem 176 may be soldered or welded to the cable conductor 142 to form the seam joint 202. The cable conductor 142 rests against the folded hem 176 and/or the inner surface of the first panel 172 for welding or soldering. The folded portion 170 increases the thickness of the contact 150 at the terminating end 162 to provide more material at the seam 200 to form the seam joint 202. In an exemplary embodiment, the folded portion 170 creates a pocket (from above) between the first panel 172 and the cable conductor 142 for the laser beam (or solder) used for laser welding to better contain the laser beam and direct the energy where needed to improve the weld joint at the seam 200.

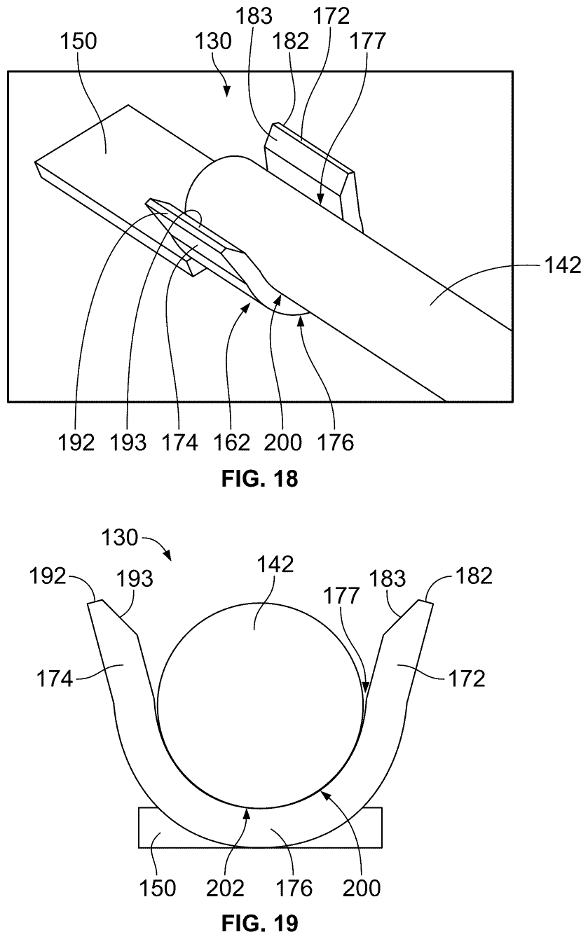

FIG. 18 is a perspective view of the cable assembly 130 in accordance with an exemplary embodiment. FIG. 19 is a cross-sectional view of the cable assembly 130 in accordance with an exemplary embodiment. FIGS. 18 and 19 show the contact 150 oriented in a different orientation than the embodiment shown in FIGS. 2 and 3. In an exemplary embodiment, the folded portion 170 extends parallel to the cable conductor 142 (for example, parallel to the cable axis of the cable 140). The contact 150 is positioned to extend along the end portion of the cable conductor 142. For example, the seam 200 extends along the folded hem 176 and/or the first panel 172 and/or the second panel 174 to form the seam joint 202. In the illustrated embodiment, the terminating end 162 extends along the bottom and/or along the sides of the conductor 142. However, in other various embodiments, the terminating ends 162 may extend along other portions of the conductor 142.

In an exemplary embodiment, the first panel 172 and second panels 174 are bent to form a cradle 177 that receives the cable conductor 142. The first and second panels 172, 174 may be curved to provide the cradle with a radius of curvature that matches the radius of curvature of the cable conductor 142. The ends of the first and second panels 172, 174 may be straight or may be curved. The ends of the first and second panels 172, 174 may be flared outward to form a funnel into the cradle 177. In an exemplary embodiment, the first edge 182 includes the swage 183 and the second edge 192 includes a swage 193 along the inner surface (for example, facing the funnel) to increase the lead-in to guide the cable conductor 142 into the cradle 177.

When assembled, the inner surfaces of the first and second panels 172, 174 face the cable conductor 142 and the inner surface of the folded hem 176 faces the cable conductor 142. The inner surfaces abut the cable conductor 142 to form the seam 200. The cable conductor 142 rests against the inner surfaces for welding or soldering. The folded hem 176 and/or the first panel 172 and/or the second panel 174 may be soldered or welded to the cable conductor 142 to form the seam joint 202. The folded portion 170 has increased thickness to provide more material at the seam 200 to form the seam joint 202. For example, the folded portion 170 provides large surface area for welding or soldering to the cable conductor 142.

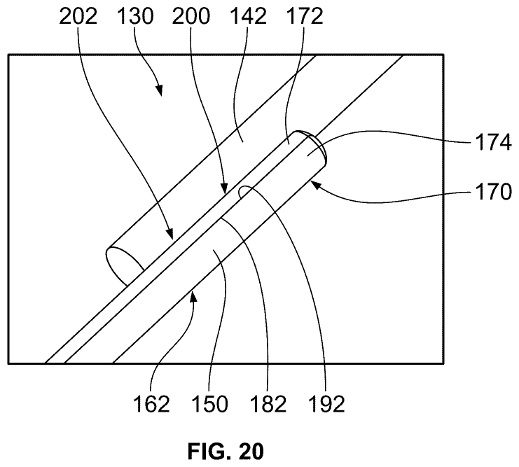

FIG. 20 is a perspective view of the cable assembly 130 in accordance with an exemplary embodiment. FIG. 20 shows the contact 150 oriented in a different orientation than the embodiment shown in FIGS. 2 and 3. In an exemplary embodiment, the folded portion 170 is formed into a pin shape. For example, the folded portion 170 is a cylindrical structure. The first and second edges 182, 192 may abut against each other. The folded portion 170 may have a diameter approximately equal to a diameter of the cable conductor 142. However, the folded portion 170 may have a larger or smaller diameter than the diameter of the cable conductor 142.

The folded portion 170 extends parallel to the cable conductor 142 (for example, parallel to the cable axis of the cable 140). The contact 150 is positioned to extend along the end portion of the cable conductor 142. For example, the seam 200 extends along the first panel 172 (or the second panel 174) to form the seam joint 202. The first panel 172 may be soldered or welded to the cable conductor 142 to form the seam joint 202. The folded portion 170 increases the thickness of the contact 150 at the terminating end 162 to provide more material at the seam 200 to form the seam joint 202. In the illustrated embodiment, the terminating end 162 extends along the side of the conductor 142. However, in other various embodiments, the terminating ends 162 may extend along other portions of the conductor 142, such as along the top or the bottom of the conductor 142 (for example, with the second panel 174 forming the seam 200).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A cable assembly comprising:
a cable including a cable conductor having an end portion;
a contact terminated to the end portion of the cable conductor, the contact including a mating end and a terminating end, the mating end having a mating interface configured to be mated to a mating contact, the terminating end configured to be joined to the end portion of the cable conductor at a termination, the terminating end including a folded portion to increase a thickness of the terminating end at the termination.

2. The cable assembly of claim 1, wherein the termination is one of soldered or welded to the end portion of the cable conductor along the folded portion.

3. The cable assembly of claim 1, wherein the folded portion has a thickness approximately twice a thickness of other portions of the contact.

4. The cable assembly of claim 1, wherein the folded portion includes a first panel and a second panel stacked to increase the thickness of the terminating end.

5. The cable assembly of claim 4, wherein the folded portion includes a folded hem defining a connecting portion between the first panel and the second panel.

6. The cable assembly of claim 5, wherein the folded hem forms a seam abutting the cable conductor and being one of soldered or welded to the end portion of the cable conductor.

7. The cable assembly of claim 5, wherein the first panel includes a first outer side extending between the hem and a first edge, the second panel including a second outer side extending between the hem and a second edge, the first panel including a first inner side opposite the first outer side extending between the hem and the first edge, the second panel including a second inner side opposite the second outer side extending between the hem in the second edge, the first inner side facing the second inner side.

8. The cable assembly of claim 7, wherein one of the first outer side or the second outer side forms a seam abutting the cable conductor and being one of soldered or welded to the end portion of the cable conductor.

9. The cable assembly of claim 7, wherein at least one of the first edge and the second edge form a seam abutting the cable conductor and being one of soldered or welded to the end portion of the cable conductor.

10. The cable assembly of claim 1, wherein the termination at the folded portion is at least half a diameter of the cable conductor.

11. The cable assembly of claim 1, wherein the folded portion includes a hem extending parallel to the cable conductor, the hem forming a seam joint along a side of the cable conductor.

12. The cable assembly of claim 1, wherein the folded portion includes a hem extending perpendicular to the cable conductor, the hem forming a butt joint along an end of the cable conductor.

13. The cable assembly of claim 1, wherein the folded portion includes a hem extending parallel to the cable conductor, the folded portion forming a butt joint along an end of the cable conductor.

14. The cable assembly of claim 1, wherein the folded portion includes multiple layers stacked to form a layered structure to increase the thickness of the terminating end.

15. The cable assembly of claim 1, wherein the contact includes a stamped and formed body having broad sides and edge sides, one of the broad sides being folded over on itself at the folded portion to form a lap joint.

16. The cable assembly of claim 1, wherein the folded portion includes a first fold member folded in a first direction and a second fold member folded in a second direction opposite the first direction.

17. A cable assembly comprising:
a cable including a cable conductor having an end portion;
a contact terminated to the end portion of the cable conductor, the contact including a stamped and formed body having a sheet thickness, the contact including a mating end and a terminating end, the mating end having a mating interface configured to be mated to a mating contact, the terminating end configured to be joined to the end portion of the cable conductor at a termination, the body at the terminating end being folded over to form a lap joint at the termination, the lap joint having a thickness greater than the sheet thickness.

18. The cable assembly of claim 17, wherein the folded portion includes a first panel and a second panel stacked to increase the thickness of the terminating end, the folded portion including a folded hem defining a connecting portion between the first panel and the second panel.

19. The cable assembly of claim 17, wherein the folded portion includes multiple layers stacked to form a layered structure to increase the thickness of the terminating end.

20. A method of forming a cable assembly, the method comprising:
providing a contact including a body extending between a mating end and a terminating end;
folding the body at the terminating end to form a lap joint at the terminating end, the lap joint having a thickness greater than a thickness of the body; and
joining the lap joint to a conductor of a cable at a seam.
